(19) United States
(12) Patent Application Publication
(10) Pub. No.: US 2007/0191179 A1
(43) Pub. Date: Aug. 16, 2007

(54) MOTOR VEHICLE

(76) Inventors: Ludger Hugenroth, Ostbevern (DE); Herbert Twiefel, Harsewinkel (DE); Heinrich Isfort, Duelmen (DE)

Correspondence Address: Striker, Striker & Stenby, 103 East Neck Road, Huntington, NY, 11743, US

(21) Appl. No.: 11/626,725

(22) Filed: Jan. 24, 2007

(30) Foreign Application Priority Data
Feb. 13, 2006 (DE) 10 2006 006 766.5

(51) Int. Cl. B60K 5/08; G06F 17/00

(52) U.S. Cl. 477/2; 701/103

(57) ABSTRACT

A motor vehicle has at least two drive units which can be operated in a drive train, with devices assigned to the drive units which permit identical or different power output from the drive units, and the power output from the drive units is coordinated such that the drive units are operated in the range of low fuel consumption. In this manner it is ensured that the drive units integrated in one drive train are operated at nearly optimal operating points.

### CROSS-REFERENCE TO A RELATED APPLICATION

The invention described and claimed hereinbelow is also described in German Patent Application DE 10 2006 006 766.5 filed on Feb. 13, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a motor vehicle with at least two drive units which can be operated in a drive train.

Publication DE 1 780 052 makes known a motor vehicle with two drive units for an agricultural application, in the case of which each of the two drive units is positioned such that the highest possible rate of work can be attained when devices or machines are installed on this motor vehicle. To equalize the output between the two drive units, it is provided that the two drive units can be coupled with each other or, under certain operating circumstances, the output from the two drive machines can be utilized together or separately. If the two drive units are integrated in the same drive train, one of the drive units always serves as a power reserve and is engaged whenever the output available from the other drive unit is below the power output required for the drive train. The system can also be designed such that each of the drive units is assigned to a separate drive train, so that, e.g., the ground drive of a motor vehicle can be supplied with energy separately from the drive of its working units. This has the advantage, in particular, that fluctuations in the speed of one system do not directly affect the other system.

A disadvantage of drive systems designed in this manner, however, is that the drive units are always operated at the operating point that always provides the drive trains with the drive energy required, regardless of whether this means a particular drive unit functions at a more favorable or less favorable operating point.

### SUMMARY OF THE INVENTION

The object of the present invention, therefore, is to avoid the disadvantages described in the related art and, in particular, to provide a device that enables the drive units integrated in a drive train to be operated at nearly optimal operating points.

In keeping with these objects and with others which will become apparent hereinafter, one feature of the present invention resides, briefly stated, in a motor vehicle, comprising at least two drive units operatable in a drive train; and means assigned to said drive units for permitting identical or different power outputs from said drive units, wherein the power output from said at least two drive units is coordinated such that said at least two drive units are operated in a range of low fuel consumption.

Given that the power output of the at least two drive units is coordinated such that the at least two drive units are operated in the range of low fuel consumption, it is ensured that the drive units integrated in a drive train are operated at nearly optimal operating points.

In an advantageous embodiment of the invention, the sum of the partial outputs from the drive units corresponds to the total amount of power required, and, to provide the partial outputs, the drive units are operated in partial load ranges with nearly identical specific fuel consumption. A design of this type has the advantage, in particular, that it is necessary to take only one fuel consumption characteristic into account during the optimization procedure. As a result, the required optimization—which typically depends on the computing capacity available—can be carried out nearly in real time.

The working units work together in a particularly fuel-saving manner when, in an advantageous embodiment, at least one drive unit is operated in the full-load range, and the at least one further drive unit is operated in a partial-load range, and the operating points of both working units are located on the same fuel consumption characteristic.

In an advantageous embodiment, a nearly real-time optimization of the operating points of the drive units is attained when the means for operating the drive units in the partial and/or full-load ranges are designed as a control and regulating device which can engage in the motor control of the particular drive unit and change it.

A design of the inventive control of the drive units which is cost-favorable and easy to implement in terms of drive technology makes it possible to operate the drive units in the partial-load and/or full-load ranges at the same engine speed. This has the advantage, in particular, that it is not necessary to provide gear stages to synchronize the various engine speeds.

In a further advantageous embodiment of the present invention, the specific fuel consumption of the drive units is defined in fuel consumption characteristics, and these fuel consumption characteristics are stored in the control and evaluation unit in a manner that allows them to be called up and edited. This has the advantage, in particular, that it enables rapid access to highly diverse fuel consumption characteristics, which allows the fuel demand to be optimized in a highly flexible manner.

An advantageous refinement of the present invention results when families of characteristics are stored in the control and evaluation unit in a manner that allows them to be called up and edited, and the families of characteristics include at least the engine characteristics of the drive units and the related fuel consumption characteristics. Optimized operating points of the drive units can therefore be determined for any power requirement.

Given that the at least two drive units have the same design and are operated on the same characteristic for the specific fuel requirement at the same engine speed, and at least one drive unit functions in the full-load range, it is possible to optimize the fuel demand of the drive units using a minimum number of characteristics that must be stored, and without the need to integrate synchronizing gear ratios.

In a further advantageous embodiment of the present invention, the at least two drive units have different designs and are operated on different characteristics for the specific fuel requirement at nearly the same engine speed, and at least one drive unit functions in full-load operation. This has the advantage, in particular, that drive units with different numbers of cylinders can also be integrated in the same drive system, and it is also possible in this case to optimize the operating points in terms of low fuel consumption of the drive units without adding gear ratios.

In an advantageous embodiment of the present invention, the drive units of the motor vehicle can be operated in the partial-load ranges at different speeds, and a gear ratio is assigned to at least one drive unit to match the rotational speeds. This increases the flexibility of optimizing the fuel consumption when the drive units are operated, since, in this case, the optimization receives an additional degree of freedom given that the condition that the engine speeds be the same is eliminated.

An advantageous refinement of the present invention also results when a large number of drive units—for which an optimized operating point is determined in the inventive manner—is assigned to the at least one drive train.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a motor vehicle in accordance with the present invention, in a side view

FIG. 2 shows a schematic illustration of the engine control according to the present invention

FIG. 3 shows a detailed depiction of various families of engine characteristics in accordance with the present invention.

### DESCRIPTION OF THE PREFERRED EMBODIMENTS

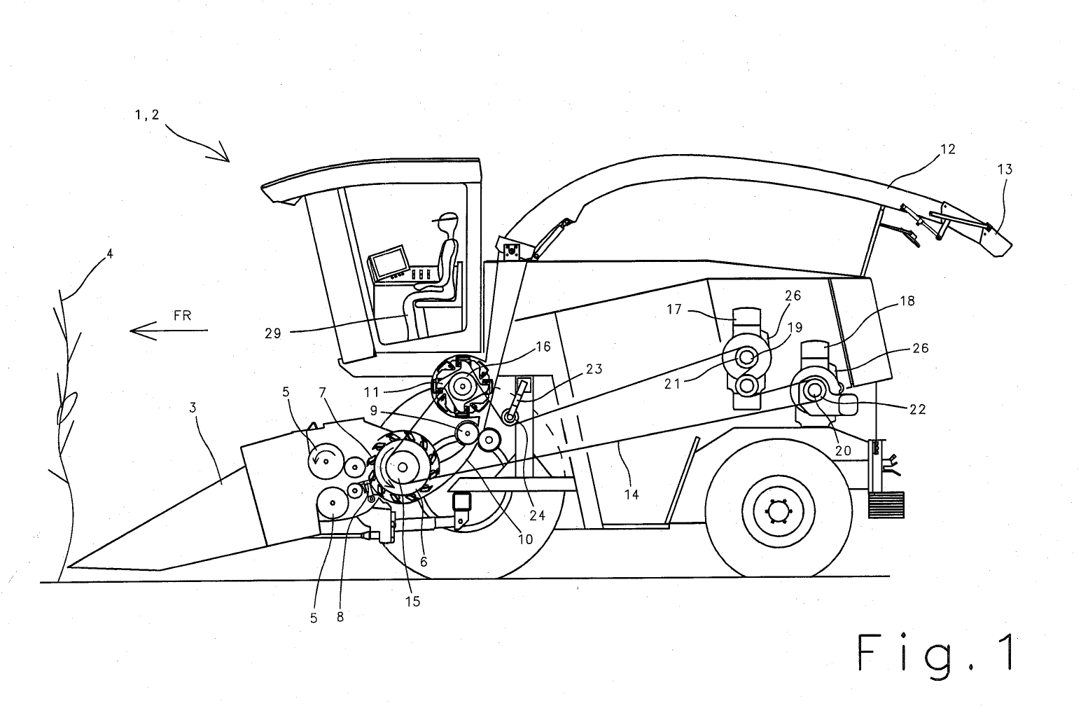

FIG. 1 shows a side view and a sectional view of a motor vehicle 2 which can be used for agricultural applications and which is designed as a self-propelled forage harvester 1. A front attachment 3 is assigned to the front, as viewed in the direction of travel FR, which picks up crop material 4 during the working operation of forage harvester 1, and which may fragmentize it, then guide it to downstream intake and pre-compression rollers 5. Intake and pre-compression rollers 5 guide crop material 4 to downstream, rotating chopper drum 6, the cutter blade 7 of which fragmentizes crop material 4 at a shear bar 8.

Fragmentized crop material 4 is subsequently transferred to a post-fragmentation device 9 and, from this point, via a conveyer chute 10, to a post-accelerator 11. Post-accelerator 11 accelerates fragmentized crop material 4 and conveys it—via a horizontally and vertically displaceable upper discharge chute 12 and an upper discharge chute flap 13 assigned thereto such that it can swivel, in order to regulate the distance the crop material stream is thrown—toward a not-shown transport device assigned to upper discharge chute 12.

In the exemplary embodiment shown, chopper drum 6 and post-accelerator 11 are connected via the same drive belt 14 and pulleys 15, 16 assigned thereto with two drive units 17, 18 designed as diesel engines of the same or different performance classes. Clutches 19, 20—which are known per se and are therefore not described in greater detail—are assigned to drive units 17, 18, thereby allowing drive units 17, 18 to be engaged or disengaged in a manner to be described in greater detail. In the exemplary embodiment shown, clutches 19, 20 are integrated directly in pulleys 21, 22 assigned to drive units 17, 18. To transfer the drive energy without slip, drive belt 14 is always pre-tensioned by one or more tensioning devices 23 using idler pulleys 24. In addition, in a manner which is known per and is therefore not depicted, front attachment 3, intake and pre-compression rollers 5 upstream of chopper drum 6, and post-fragmentation device 9 are driven by drive units 17, 18.

It is within the scope of the present invention for inventive drive units 17, 18 to be located on any type of motor vehicle 2, e.g., trucks, construction vehicles or watercraft, in order to supply drive energy to drive trains integrated in these vehicles.

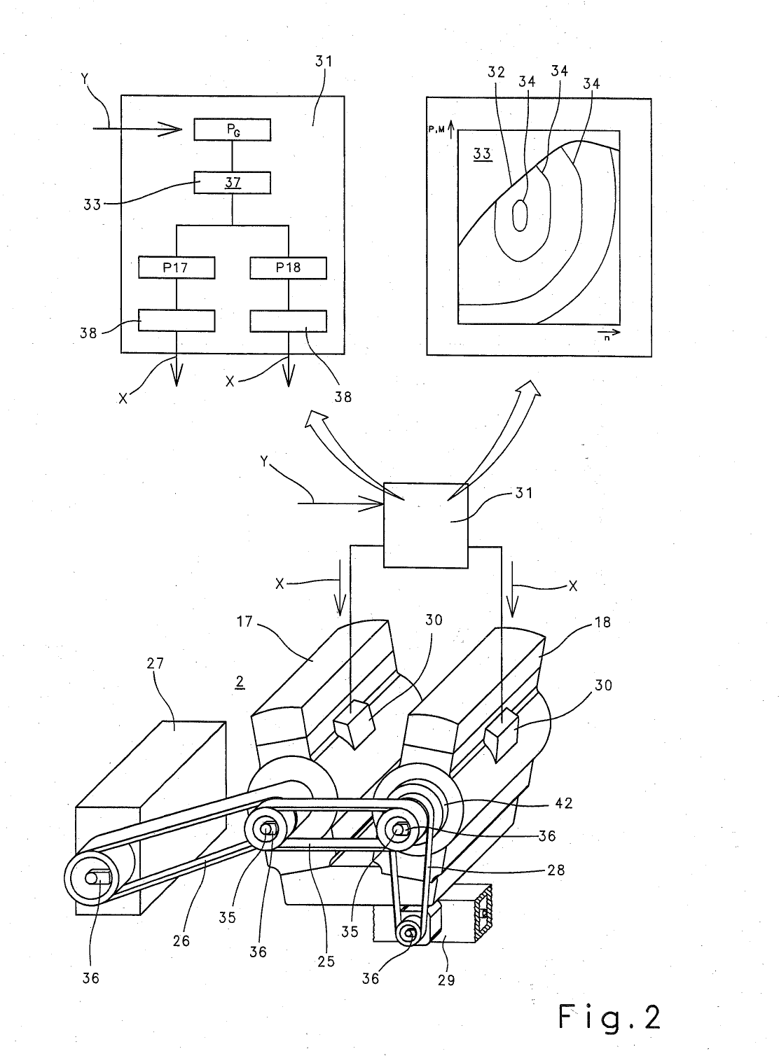

In FIG. 2, the invention is described with reference to a system of drive units 17, 18, which is independent of any special type of motor vehicle 2. In the exemplary embodiment shown, drive units 17, 18 are connected with each other via a first drive train 25. In addition, drive unit 17 supplies at least one consumer 27 with drive energy via a further drive train 26. Further drive unit 18 is integrated in a separate drive train 28 which can drive, e.g., a ground drive of a motor vehicle 2. According to the present invention, engine controls 30 of drive units 17, 18—which are designed as internal combustion engines, e.g., diesel engines—are connected with a control and evaluation unit 31 which is capable of influencing engine controls 30 using suitable input signals X.

In a manner according to the present invention, engine characteristics 32—which are known per se—are stored in control and evaluation unit 31; engine characteristics 32 indicate the maximum amount of power P available or the maximum amount of torque M available at a defined engine speed n. Stored family of characteristics 33 also includes fuel consumption characteristics 34, each of which indicates—for a nearly constant fuel consumption—how much engine power P or engine torque M is available, and associated engine speed n, in a manner that allows this information to be called up and edited.

To ensure that families of characteristics 33 stored in control and evaluation unit 31 can be flexibly adapted to different drive units 17, 18, the families of characteristics are stored in control and evaluation unit 31 in a manner that allows them to be called up and edited. Given that torque sensors 36—which are known per se—are assigned either to consumers 27, 29 or drive shafts 35 of drive units 17, 18, torque signals Y can be transmitted to control and evaluation unit 31, based on which control and evaluation unit 31 determines a total amount of power required PG to supply old drive trains 25, 26, 28—which are coupled with drive units 17, 18—with drive energy. This total amount of power required PG is then distributed among individual drive units 17, 18—with reference to family of characteristics 33 which is stored in control and evaluation unit 31 and will be described in greater detail—such that each of the drive units can be operated in a range of low fuel consumption.

After program step 37—which takes into account the interrelationships defined in stored family of characteristics 33—is carried out in control and evaluation unit 31, optimized values for power P17, P18 to be provided by particular drive unit 17, 18 are available. In a further processing step 38, these optimized performance data P17, P18 are coded in input signals X mentioned above and are transmitted to engine controls 30 of drive units 17, 18. In a manner known per se, engine controls 30 are designed such that they can regulate the fuel and air supply to the drive units and, if the drive units are designed as spark ignition engines, they can regulate the moment of ignition, with consideration for the amount of engine torque M to be generated.

After various torque sensors 36 have picked up torque signals Y from various drive trains 25, 26, 27 to be driven by drive units 17, 18 and forwarded them to control and evaluation unit 31, the latter uses this information to determine a total amount of power required PG for the motor vehicle. Since the physical variable “power” is proportional to the physical variable “torque”, it is also possible here to determine—instead of the total amount of power required—the total torque to be output by drive units 17, 18. Based on the total power requirement which was determined or the total torque to be generated, the partial outputs P17, P18 to be provided by drive units 17, 18 are determined in a first, previously mentioned program step 37 with consideration for family of characteristics 33 stored in control and evaluation unit 31.

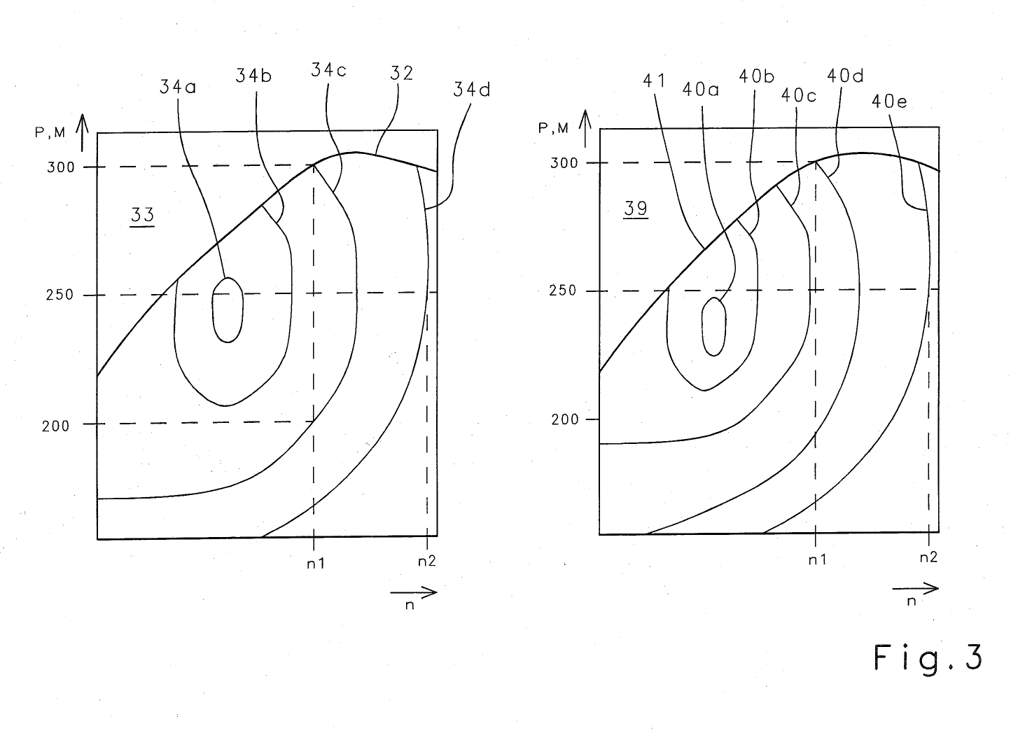

The determination of these partial outputs P17, P18 is depicted schematically in FIG. 3. The depiction on the left shows the determination of partial outputs P17, P18 for the case in which the at least two drive units 17, 18 are engines having identical or nearly identical designs, e.g., in-line, six-cylinder diesel engines. In the exemplary embodiment shown, it is assumed, e.g., that total power requirement PG which was determined is 500 kW. Since drive units 17, 18 are usually integrated in the same drive system without a cost-intensive, continuously variable transmission, it is absolutely necessary for all integrated drive units to run at the same engine speed n. As shown in the depiction on the left in FIG. 3, according to the related art, the total amount of power required, i.e., 500 kW, would be divided equally between drive units 17, 18, so that each drive unit 17, 18 provides an engine output of 250 kW at an engine speed n2. The operating point of drive units 17, 18 is therefore located on fuel consumption characteristic 34d; the fuel consumption of individual fuel consumption characteristics 34 increases as index a-d increases, i.e., the lowest fuel consumption is attained when drive units 17, 18 are operated on a more inwardly-located fuel consumption characteristic 34.

Given that, according to the present invention, control and evaluation unit 31 optimizes the operating points of drive units 17, 18 with consideration for stored families of characteristics 33 and in terms of low fuel consumption, the total amount of power required of PG=500 kW is distributed such that one drive unit 17 provides a drive output of P17=200 kW, and the other drive unit 18 provides a drive output of P18=300 kW. Further drive unit 18 provides its drive power P18 in full-load operation. Both drive units 17, 18 operate at an engine speed n1, and in an operating point located on fuel consumption characteristic 34c. In both cases, drive units 17, 18 provide a total output of 500 kW. In the inventive application, however, they do so at a much lower engine speed n1 of drive units 17, 18, so that the operating points of drive units 17, 18 are also located on a fuel consumption characteristic 34c, which results in lower fuel consumption than if the total amount of power required were divided equally between individual drive units 17, 18.

According to the present invention, a similar result can be attained with drive systems having drive units 17, 18 with different designs. This is the case, e.g., when drive unit 17 is designed as a six-cylinder engine, and further drive unit 18 is designed as an eight-cylinder engine. In this case, family of characteristics 33 depicted on the left in FIG. 3 then applies for first drive unit 17, and family of characteristics 39 depicted on the right applies for further drive unit 18. Due to the displacement, which typically increases in proportion to the number of pistons, the fuel demand also increases with the number of pistons. As a result, at least the fuel consumption characteristics 40a-e of drive unit 18 are shifted toward lower engine speeds n when the number of cylinders is higher, while engine characteristic 41 itself can be nearly identical to engine characteristic 32 of the other drive unit 17.

For example, in FIG. 3, it is assumed that total power required is PG=500 kW. In a similar manner and with consideration for the optimization criterium of “low fuel demand”, this results in partial outputs of P18=300 kW and P17=200 kW to be provided by drive units 17, 18 at the same engine speed n1. Since it has more cylinders, drive unit 18 now functions in an operating point located on fuel consumption characteristic 40d, but in the full-load range. Increasing indices represent increasing fuel demand. It is therefore clear that, in this case as well, dividing the total power requirement of 500 kW equally between the two drive units 17, 18 would result in higher fuel consumption, since drive units 17, 18 would then function at operating points that would be located on fuel consumption characteristics 34d and 40e. Increasing indices again represent the increasing fuel demand, as an example.

Even greater flexibility in terms of optimizing fuel consumption during operation of several drive units 17, 18 coupled with each other in partial-load and/or full-load operation results when a gear stage 42 is assigned to at least one drive unit 18 according to FIG. 2, which enables the output speed of this further drive unit 18 to be synchronized with the output speed of first drive unit 17. It is within the scope of the present invention for gear stage 42 to also be designed as a summarizing gear which synchronizes the partial outputs provided by drive units 17, 18 at different speeds and optionally supplies them to highly diverse consumers 27, 29 via various outputs 26, 28.

It is also within the scope of the present invention to assign a large number of drive units 17, 18 to the motor vehicle, which are coupled with each other in the manner according to the present invention.

It will be understood that each of the elements described above, or two or more together, may also find a useful application in other types of constructions differing from the type described above.

While the invention has been illustrated and described as embodied in a motor vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A motor vehicle, comprising at least two drive units operatable in a drive train; and means assigned to said drive units for permitting identical or different power output from said drive units, wherein the power output from said at least two drive units is coordinated such that said at least two drive units are operated in a range of low fuel consumption.

2. A motor vehicle as defined in claim 1, wherein said means is configured so that a sum of partial outputs from said drive units corresponds to a total amount of power required, and, to provide the partial outputs, said drive units are operated at operating points with substantially identical specific fuel consumption.

3. A motor vehicle as defined in claim 1; and further comprising means for operating one of said drive units in a full-load range and the other of said drive units in a partial-load range, wherein operating points of said two drive units are located on a same fuel consumption characteristic.

4. A motor vehicle as defined in claim 3, wherein said means for operating the drive units in the full-load range and the partial-load range is configured as a control and regulating device engaging in a motor control of a particular one of said drive units and changing it.

5. A motor vehicle as defined in claim 3, wherein said means is configured so that said drive units are operated in the partial and/or full-load ranges at a same engine speed.

6. A motor vehicle as defined in claim 1; and further comprising a control and evaluation unit configured so that a specific fuel consumption of said drive units is defined in fuel consumption characteristics, and these fuel consumptions characteristics are stored in said control and evaluation unit in a manner that allows the fuel consumption characteristics to be called up and edited.

7. A motor vehicle as defined in claim 1; and further comprising a control and evaluation unit configured so that families of characteristics are stored in said control and evaluation unit in a manner that allows the characteristics to be called up and edited, and the families of characteristics include at least engine characteristics of said drive units and related fuel consumption characteristics.

8. A motor vehicle as defined in claim 1, wherein said at least two drive units have a same design and are operated on a same fuel consumption characteristic and substantially a same engine speed, and at least one of said drive units functions in full-load operation.

9. A motor vehicle as defined in claim 1, wherein said at least two drive units have different designs and are operated on different fuel consumption characteristics at substantially a same engine speed, and at least one of said drive units functions in full-load operation.

10. A motor vehicle as defined in claim 1, wherein said drive units are configured so that they are operated in partial load ranges at different engine speeds, and a gear stage is assigned to at least one of said drive units to match rotational speeds.

11. A motor vehicle as defined in claim 1, wherein a plurality of said drive units is assigned to the at least one drive train.
